(19) United States
(12) Patent Application Publication
(10) Pub. No.: US 2009/0055241 A1
(43) Pub. Date: Feb. 26, 2009

(54) System and Method for Estimating a Qualiifed Impression Count for Advertising Data in a Communication System

(75) Inventors: Wenge Chen, Austin, TX (US); Eric Puetz, Georgetown, TX (US); Yetik Serbest, Austin, TX (US); Michael Pepe, Austin, TX (US)

Correspondence Address: AT&T Legal Department;Attn: Patent Docketing, One AT&T Way,, Room 2A-207, Bedminster, NJ, 07921, US

(73) Assignee: ATT Knowledge Ventures L.P., Reno, NV (US)

(21) Appl. No.: 11/843,973

(22) Filed: Aug. 23, 2007

(51) Int. Cl. G06Q 30/00; G06Q 10/00; G06F 17/10; G06F 7/08; G06F 17/30

(52) U.S. Cl. 705/10; 707/7; 707/100; 707/E17.032; 707/E17.033

(57) ABSTRACT

A method and system for estimating a qualified impression count in a communication network, the method comprising receiving at a server, impression quality factors data comprising subscriber device state data indicative of a degree of active advertising data viewing, subscriber device type data indicative of a type of subscriber device receiving the advertising data and subscriber type data indicative of a type of subscriber viewing the advertising data; sorting the impression quality factors data into impression quality factors categories data; applying weights to the sorted impression quality factors categories data; accumulating the weighted impression quality factors categories data into the impression quality factors categories; applying unique curves to at least two of the accumulated impression quality factors categories data to generate curve adjusted impression quality factors categories data; correlating the curve adjusted impression quality factors categories data with advertising quality criteria data; and estimating the qualified impression count from the correlation.

### FIELD OF THE DISCLOSURE

The present disclosure relates to counting advertising impressions for television commercials.

### BACKGROUND OF THE DISCLOSURE

Targeted advertisements have historically been mailed to large targeted geographic areas such as a particular city, so that regional advertisers reach only persons who are deemed by the advertiser as most likely to be responsive to their advertisements. For example, a car dealer in Dallas, Tex. would send advertisements only to residents of Dallas, Tex. and surrounding areas.

Advertisers can potentially save advertising dollars by targeting their advertisements rather than indiscriminately broadcasting their advertisements to a general population of recipients.

### BRIEF DESCRIPTION OF THE DRAWINGS

FIG. 1 depicts an illustrative embodiment of a system for sending advertising data and monitoring data sent and received by various subscriber devices associated with a subscriber for monitoring advertising impression quality factors data to estimate a qualified impression count;

FIG. 2 depicts another illustrative embodiment of a system for sending advertising data and monitoring data sent and received by various subscriber devices associated with subscribers in a communication system such as an IPTV system for monitoring advertising impression quality factors data to estimate a qualified impression count;

FIG. 3 illustrates a histogram of subscribers viewing a particular advertisement in another particular illustrative embodiment;

FIG. 4 depicts a flow chart of functions performed in another illustrative embodiment for delivering advertising data monitoring data sent and received by various subscriber devices associated with subscribers in a communication system, such as an IPTV system for monitoring advertising impression quality factors data to estimate a qualified impression count;

FIG. 5 depicts a data structure embedded in a computer readable medium that is used by a processor and method for estimating a qualified impression count in a communication system, such as an IPTV system; and

FIG. 6 depicts an illustrative embodiment of a machine for performing functions disclosed in another illustrative embodiment for estimating a qualified impression count in a communication system, such as an IPTV system.

### DETAILED DESCRIPTION

A particular illustrative embodiment discloses a framework to monitor and correlate impression quality factors data derived from subscriber activity, device states, device types and demographic data. The selection and transaction data transferred in a communication network from subscriber devices across bundled services such as Internet protocol television (IPTV), voice over internet protocol (VoIP) and high-speed Internet to estimate a qualified impression count for advertising delivered to subscriber devices across the bundled services. A subscriber's registration data can also be correlated with subscriber activity data to further refine the qualified impression count data. The collected impression quality factors data enables assessment of the quality of advertising impression counts delivered as broadcast, multicast and targeted, personalized advertisements and commercials on an individual service basis (IPTV, VoIP or Internet) to subscriber devices.

In another particular illustrative embodiment, advertising data is delivered via Internet web page advertisements (banners, videos, links, audios, etc.), mobile cell phone advertisements (banners, videos, audios, links, etc.), and/or IPTV advertisements (banners, videos, audios, etc.), to subscriber end user devices (referred to herein as subscriber devices). In another particular embodiment, advertising data is delivered to a particular subscriber device which the subscriber is presently using, referred to herein as the “current subscriber device.” In another particular embodiment, the advertising data is delivered to a subscriber device other than the current subscriber device.

In another illustrative embodiment, targeted advertising data is directed to subscribers or groups of subscribers based on their interests and demographics derived from subscriber profiles for the subscribers. The subscriber profiles are based on activities for subscribers on IPTV, Internet and VoIP. Each STB or residential gateway (RG) associated with a subscriber household collects impression quality factors data including advertising device state data, multicast join, advertising playback and duration of playback, etc. for assessing when a subscriber is tuned to and/or views general and targeted advertising data sent to one or more of the subscriber devices for viewing advertising or “advertising devices” associated with a particular subscriber. In another particular illustrative embodiment, the communication system comprises an IPTV system that provides VoIP, IPTV and Internet services.

Another particular embodiment collects impression quality factors data associated with each of a plurality of subscribers from STBs, residential gate ways (RGs), deep packet inspection (DPI) devices that monitor traffic between subscriber devices and communication network servers such as IPTV servers, VoIP servers and Internet servers that send the advertising data to subscriber devices and receive device state data from the subscriber devices associated with a particular subscriber or subscriber household. Another particular illustrative embodiment derives impression quality factors data including but not limited to subscriber related statistics from the subscriber activity data, including but not limited to channels watched and timestamps, programs watched and timestamps, programs recorded, videos ordered via on demand. Additionally, communication network gateways such as residential gateways associate ecommerce purchases on the Internet, Internet surfing history, video on demand purchases associated with the IPTV system are stored in a subscriber activity data profile. The above subscriber related statistics and subscriber profile data are stored in the subscriber activity data profile. The subscriber activity data profiles are continuously and dynamically updated in a “self learning mode” in real time so that division of the impression quality factors data into impression quality factors categories is performed in essentially real time. Device states are collected at each subscriber device and reported to the communication network for updating the subscriber activity data profiles and impression quality factors data.

In another particular embodiment a method for estimating a qualified impression count in a communication network is disclosed, the method comprising receiving at a server, impression quality factors data comprising subscriber device state data indicative of a degree of active advertising data viewing, subscriber device type data indicative of a type of subscriber device receiving the advertising data and subscriber type data indicative of a type of subscriber viewing the advertising data; sorting the impression quality factors data into impression quality factors categories data; applying weights to the sorted impression quality factors categories data; accumulating the weighted impression quality factors categories data into the impression quality factors categories; applying unique curves to at least two of the accumulated impression quality factors categories data to generate curve adjusted impression quality factors categories data; correlating the curve adjusted impression quality factors categories data with advertising quality criteria data; and estimating the qualified impression count from the correlation. In another particular embodiment, the impression quality factors data are received from at least one of the set consisting of a subscriber device and a local server and the method further comprises generating a histogram of accumulated weighted impression quality factors categories data. In another particular embodiment, the method further comprises charging a fee based on the qualified impression count.

In another particular embodiment of the method the plurality of curves are selected from the group consisting of an exponential curve, an S curve and a linear curve. In another particular embodiment of the method the subscriber device type is selected from the group consisting of a personal computer, a mobile phone a television monitor, personal data assistant and web tablet. In another particular embodiment of the method the subscriber type is selected from the group consisting of gender, age, income, geographic location, race and language. In another particular embodiment of the method the subscriber device state is selected from the group consisting of speaker volume, display on duration, display off duration and multiple device usage, end user device preference, and current device. In another particular embodiment of the method the device state is collected at programmable time intervals, t selected to filter out channel surfing.

In another particular embodiment of the method applying weights to sorted impression quality factors categories data is based on at least one selected from the group consisting of subscriber type, level of active viewing, duration of viewing, preferred subscriber device and subscriber device type. In another particular embodiment a system for estimating a qualified impression count in a communication network is disclosed, the system comprising a processor in data communication with a computer readable medium; and a computer program embedded in the computer readable medium, the computer program comprising instructions to receive at a server, impression quality factors data comprising subscriber device state data indicative of a degree of active advertising data viewing, subscriber device type data indicative of a type of subscriber device receiving the advertising data and subscriber type data indicative of a type of subscriber viewing the advertising data, instructions to sort the impression quality factors data into impression quality factors categories data, instructions to apply weights to the sorted impression quality factors categories data, instructions to accumulate the weighted impression quality factors categories data into the impression quality factors categories; instructions to apply unique curves to at least two of the accumulated impression quality factors categories data to generate curve adjusted impression quality factors categories data; instructions to correlate the curve adjusted impression quality factors categories data with advertising quality criteria data; and instructions to estimate the qualified impression count from the correlation.

In another particular embodiment of the system, the impression quality factors data are received from at least one of the set consisting of a subscriber device and a local server and the computer program further comprises instructions to generate a histogram of accumulated weighted impression quality factors categories data. In another particular embodiment of the system the computer program further comprises instructions to charge a fee based on the qualified impression count. In another particular embodiment of the system the computer program further comprises the plurality of curves are selected from the group consisting of an exponential curve, an S curve and a linear curve. In another particular embodiment of the system the subscriber device type is selected from the group consisting of a personal computer, a mobile phone a television monitor, personal data assistant and web tablet. In another particular embodiment of the system the computer program further comprises the subscriber type is selected from the group consisting of gender, age, income, geographic location, race and language.

In another particular embodiment of the system the computer program further comprises the subscriber device state is selected from the group consisting of speaker volume, display on duration, display off duration and multiple device usage, end user device preference, and current device. In another particular embodiment of the system the device state is collected at programmable time intervals, t selected to filter out channel surfing. In another particular embodiment of the system, applying weights to sorted impression quality factors categories data is based on at least one selected from the group consisting of subscriber type level of active viewing duration of viewing, preferred subscriber device, and subscriber device type. In another particular embodiment, a data structure embedded in a computer readable medium is disclosed, the data structure comprising a first field for storing data indicative of qualified impression count data based on curve adjusted impression quality data estimated by applying a curve to accumulated quality factors category data.

In another particular embodiment the data structure further comprises a second field for storing data indicative of a curve adjusted advertising impression quality for at least one of a plurality impression quality factors categories data, wherein the curve adjusted impression quality data is estimate by applying a curve to accumulated quality factors categories data. In another particular embodiment the data structure further comprises a second field for storing data representing and advertising device state indicative of a degree of active advertising viewing data, wherein the degree of active advertising viewing is used to adjust the weighting of the plurality impression quality factors categories data. In another particular embodiment the data structure further comprises a fourth field for storing data representing a subscriber device type indicative of a type of advertising device selected from the group consisting of a personal computer, a mobile phone, a television monitor, a personal data assistant and a web tablet.

In another illustrative embodiment, a computer readable medium is disclosed containing computer program instructions that when executed by a computer perform a method for sending impression quality factors data for estimating a qualified impression count in a communication network, the computer program comprising instructions to collect impression quality factors data at a subscriber device; and instructions to send from the subscriber device to a server, the impression quality factors data comprising subscriber device state data indicative of a degree of active advertising data viewing, subscriber device type data indicative of a type of subscriber device receiving the advertising data and subscriber type data indicative of a type of subscriber viewing the advertising data.

In another illustrative embodiment, a subscriber device is disclosed for estimating a qualified impression count in a communication network, the subscriber device comprising a processor in data communication with a computer readable medium; and a computer program embedded in the computer readable medium, the computer program comprising instructions to collect impression quality factors data at the subscriber device and instructions to send from the subscriber device to a server, impression quality factors data comprising subscriber device state data indicative of a degree of active advertising data viewing, subscriber device type data indicative of a type of subscriber device receiving the advertising data and subscriber type data indicative of a type of subscriber viewing the advertising data.

A subscriber impression quality factors data profile can be built by correlating such subscriber related statistics and the subscriber activity data profile along with other subscriber data and information such as gender, age, income, languages spoken, areas of interest, etc. volunteered by a subscriber during an IPTV registration process. The subscriber activity data profile information will contain data for which a subscriber has opted in for monitoring and use by the IPTV system for the purposes of receiving targeted advertising data. Impression quality factors data can be inferred based on the subscriber activity data profile. Based on subscribers' interests, background, and subscriber profiling results, one of the following targeted advertising data delivery described herein or an equivalent thereof can be utilized to estimated qualified impression counts for targeted advertising data provided to personalized advertising data and television commercial delivery to IPTV television displays, portable subscriber data and messaging devices such as mobile or cell phones and website banners and pop up displays on a PC or Laptop.

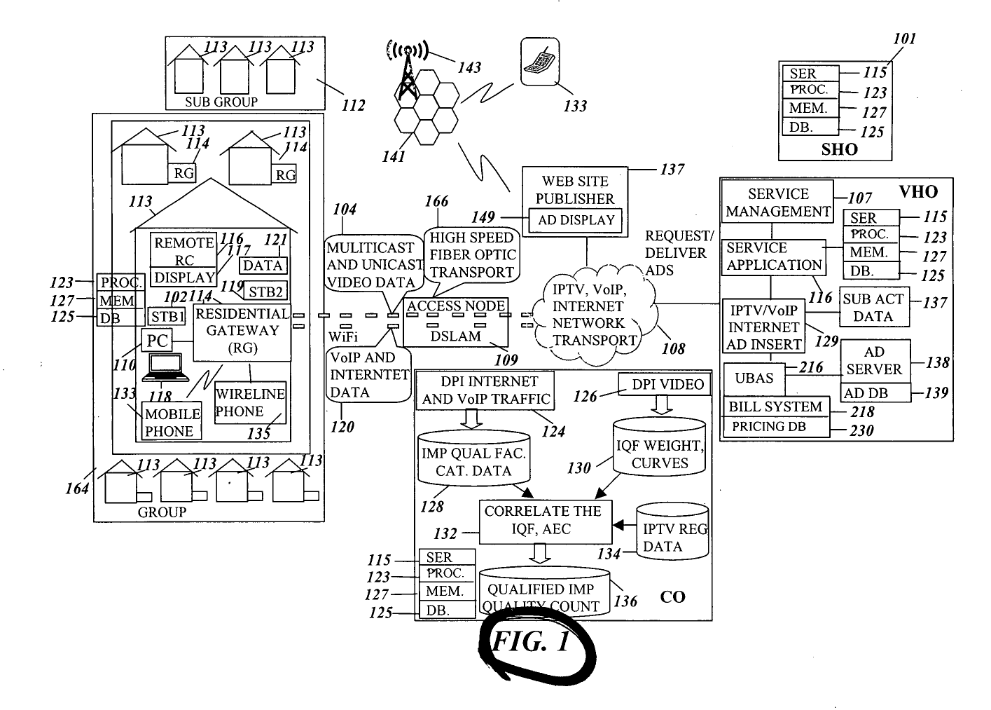

Turning now to FIG. 1, the IPTV system 100 delivers content and targeted advertising to subscriber house holds 113 and associated end user devices (referred to herein as subscriber devices) which may be inside or outside of the household. Television advertising data is inserted context by the advertising server 138. In the IPTV system, IPTV channels are first broadcast in an internet protocol from a server at a super head end (SHO) 101 to a regional or local IPTV VHO server 103, to a central office (CO) server 105. The IPTV system 100 includes a hierarchically arranged network of servers wherein the SHO transmits video and advertising data to a video head end (VHO) 103-end server location close to a subscriber, such as a CO server 105. The IPTV servers also provide data communication for Internet and VoIP services to subscribers. Actively viewed IPTV channels are sent in an Internet protocol (IP) data multicast group to access nodes such as digital subscriber line access multiplexer (DSLAM) 109. A multicast for a particular IPTV channel is joined by the set-top boxes (STBs) at IPTV subscriber homes from the DSLAM. Each SHO, VHO, CO, and STB includes a processor 123, a memory 127 and a database 125. The CO 105 server 115 delivers television content via multicast and television advertising data via unicast or multicast depending on the target television advertising group of end user client subscriber devices to which the advertising data is directed.

In another particular embodiment, subscriber devices, including but not limited to, wire line phones 135, portable phones 133, lap top computers 118, personal computers (PC) 110 and STBs 102, 119 communicate with the communication system, i.e., IPTV system through residential gateway (RG) 114 and high speed communication lines 166, 104. In another particular embodiment, DPI devices 124, 126 inspect data VoIP, Internet data 120 and IPTV video, commands and Meta data 104 (multicast and unicast) between the subscriber devices and the IPTV system severs. In another illustrative embodiment impression quality factors data are monitored and collected whether or not the subscriber's devices are in the household 113 or mobile outside of the household. When outside of the household, subscriber mobile device data is monitored by communication network (e.g. IPTV) servers which associate the impression quality factors data with particular subscribers. In another particular embodiment, impression quality factors data including subscriber activity data such as communication transactions are inspected by DPI devices located in a communication system, e.g., IPTV system servers. These communication system servers route the impression quality factors data to a VHO or CO in which the impression quality factors data for a subscriber are stored for processing.

In another particular embodiment, impression quality factors data for all subscribers served by a particular local server such as a CO are accumulated at the particular server or CO in a particular geographic region and averaged together to form CO level impression quality factors category data for the subscribers served by the CO. This CO level impression quality factors data associated with the local CO and particular geographic regions are factored into the impression quality factors data for each subscriber associated with the CO to identify geographic tendencies for impression quality factors data and impression quality for different advertising impression quality factors categories in particular regions and demographic groups served by particular COs.

As shown in FIG. 1 advertising sub groups 112 (comprising a group of subscriber house holds 113) receive multicast advertising data in video data stream 104 from CO server 115 via DSLAM 109 at a STB 102. Subscriber groups 164 are formed as a group of subscriber sub groups 112. Individual households 113 receive advertising data at set top box 102 or one of the other subscriber devices. More than one STB (see STB1 102 and STB2 119) can be located in an individual household 113 and each individual STB can receive a separate unicast advertising stream on IPTV transport 108. In another particular illustrative embodiment separate and unique advertising data are displayed at each set top box (STB) 102, 119 tailored to target the particular subscriber watching television at that particular STB. Each STB 102,119 has an associated remote control (RC) 116 and video display 117. The subscriber via the RC selects channels for a video data viewing selection (video programs, games, movies, video on demand) and places orders for products and services over the IPTV system 100.

FIG. 1 depicts an illustrative communication system, including but not limited to a television advertising insertion system wherein television advertising data can be inserted at an IPTV (SHO, VHO, CO) server or at the end user client subscriber device, for example, an STB, mobile phone, web browser or personal computer. Advertising data can be inserted into an IPTV video stream via advertising insertion device 107 at the IPTV VHO server 103 or at one of the STBs 102, 119. The IPTV servers include an advertising server 138 and an advertising database 139. The advertising data is selected by advertising selection element 129 from the advertising database 139 based on the holistic subscriber profile and delivered by the VHO advertising server 138 to the IPTV VHO server 115. A super head end (SHO) 101 distributes data to a regional video head end (VHO) 103 which distributes data to local central offices (CO) 105 which distribute data to a DSLAM access node to subscriber devices such as STBs 102,119. Advertising data is also selected based on the holistic subscriber profile and sent to a mobile phone or computer associated with the subscriber. The holistic subscriber profile is built based on a subscriber's IPTV, Internet and VoIP activity.

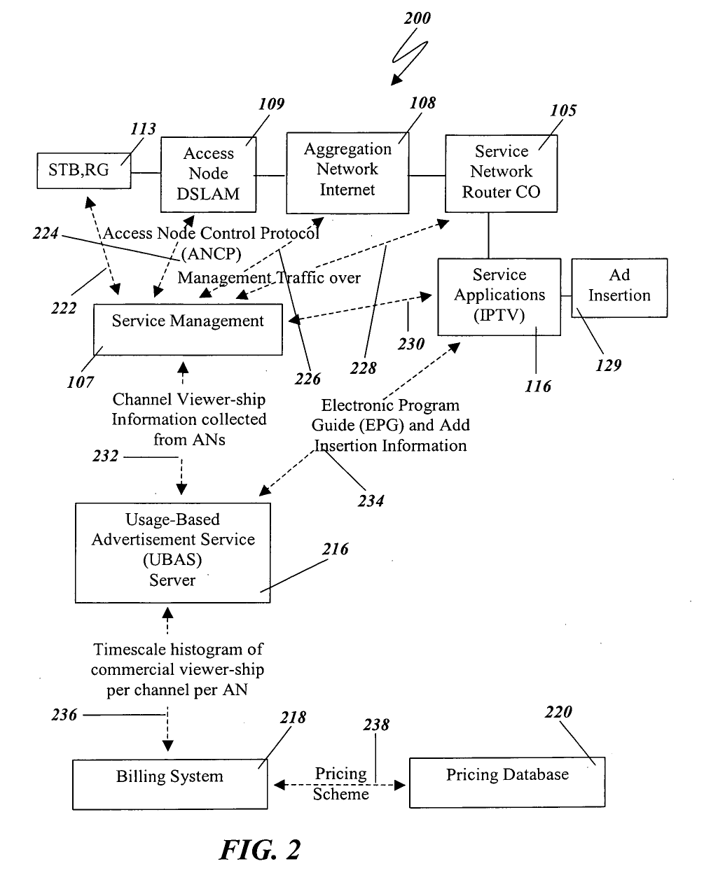

FIG. 2 depicts another illustrative embodiment of a system for sending advertising data and monitoring data sent and received by various subscriber devices associated with subscribers in an IPTV system 100 for monitoring advertising impression quality factors data. As shown in FIG. 2, in a particular illustrated embodiment, a subscriber household 113 sends impression quality factors data from an RG or STB in a subscriber household or from a mobile device to an access node such as a DSLAM 109 or to Service management function 107. When sent directly to the service management function, the identity of the subscriber is associated with the impression quality factors data. The identity of the subscriber is stripped off of the data as it is aggregated in the aggregation network or Internet. The access node 109 sends data to an aggregation network 108 such as the Internet. The aggregation network or Internet sends the impression quality factors data to service network 105 which in an illustrative embodiment can be a router or CO.

In another particular illustrative embodiment the service applications are provided by a communication network such as an IPTV triple play network. The service applications include but are not limited to a triple-play network providing IPTV, Internet and VoIP (herein referred to as an IPTV network). Service network 105 sends data to the service application 116 which in another particular illustrative embodiment is an IPTV network 116. Advertisements are inserted into the IPTV system by advertising insertion function 129. The service management function 107 communicates with the subscriber household 113 and collects the subscriber data comprising the impression quality factors data from the household, the access node, aggregation network, service network and service applications.

In another particular illustrative embodiment access node control protocol (ANCP) is used to communicate between the service management function 107 in the communication network and an access node 109. In another particular illustrative embodiment access node 109 is a digital subscriber access line multiplexer or DSLAM. In another illustrative embodiment, the aggregation network or central office 109 communicates with the service management function 107. In another particular illustrative embodiment, the service management function communicates with the service network 108. In another particular illustrative embodiment, the service management function communicates with the service application or IPTV system over communication path 230.

In another particular illustrative embodiment, the service management function 107 receives impression quality factors data, including but not limited to device state data indicative of a degree of active advertising data viewing, device type data indicative of a type of advertising device receiving the advertising data and subscriber type data indicative of a type of subscriber viewing the advertising data. The impression quality factors data further includes but is not limited to channel viewer ship data including but not limited to multicast join data, subscriber device state data and subscriber activity data collected from the access node. The service management function receives the impression quality factors data and sends the data to the user based advertisement service server 216. The user based advertisement server collects impression quality factors data, applies weights and curves 130, correlates the weighted and accumulated impression quality factors categories data 128 with advertising quality criteria data to generate the qualified impression quality count 136. In another particular illustrative embodiment, a timescale histogram of commercial viewer ship per channel per access node is communicated from the user based advertisement service server 216 to a billing system 218. The billing system 218 communicates a pricing scheme over communication path 238 to a pricing database 220. As shown in FIG. 1 impression quality factors data and impression quality factors categories data 128, impression quality factor categories weights and curves 130 and qualified impression quality count data 136 are stored at CO 105. The impression quality factors categories data are correlated 132 in the CO.

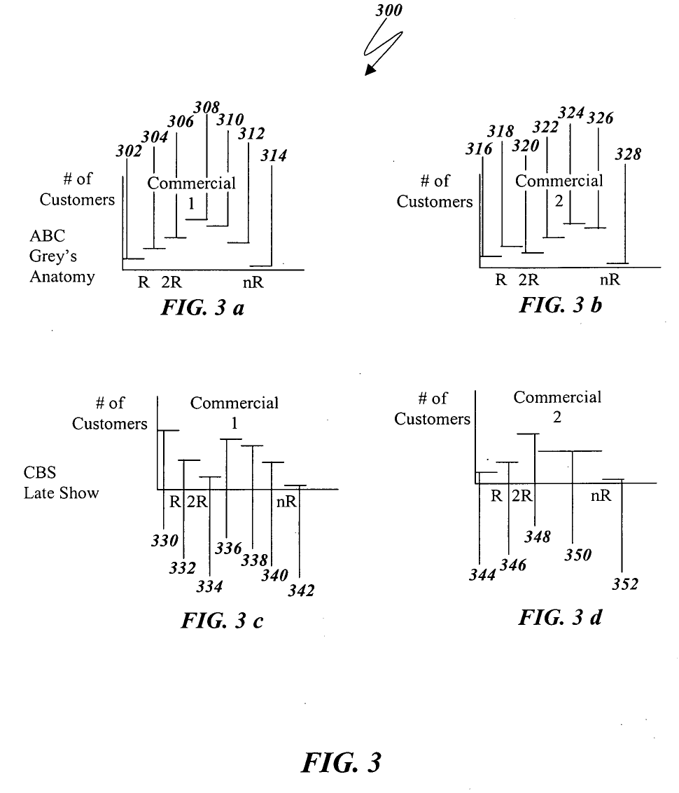

Turning now to FIG. 3, in another particular illustrative embodiment, a timescale histogram 300 is illustrated. In another particular illustrative embodiment, the particular embodiment correlates the impression quality factors data with a television and advertising broadcast schedule or electronic program guide (EPG) that includes commercial airing times for broad cast and targeted advertisements on a per subscriber basis, to determine which subscribers are tuned into a particular program or channel during a particular commercial's run time.

The subscriber device state and subscriber type from the impression quality factors data are used to determine the level of active viewing and the quality of the impression, as discussed below. The timescale histogram 300 comprises a number of subscribers per time interval who are tuned to the multicast join and thus watching the television commercial. Additional advertising impressions are collected, weighted and accumulated for other devices upon which the advertisement can be viewed. In another particular embodiment, a client software program is installed on each subscriber device to detect playback or viewing of advertising data for digital video recorders, portable MP3/video players, mobile telephones and personal computers, etc. As an impression is detected on a subscriber device the impression is weighted and accumulated for each viewing or portion thereof. The impressions can be weighted according to the type of viewer or subscriber type, level of active viewing and device type, as discussed below. Thus for a particular television show such as Grey's Anatomy, a timescale histogram illustrates a number of customers during a first commercial, commercial 1 that were tuned in to Grey's anatomy.

As shown in FIG. 3, a number of customers viewing the commercial or advertising data vary at each time in a time interval FIG. 3 a 302, 304, 306, 308, 310, 312 and 314. In another particular embodiment, the number of customers, who viewed commercial 2 during Grey's anatomy are shown during different time periods, as illustrated in FIG. 3 b 316, 318, 320, 342, 324, 326, and 328. In another particular illustrative embodiment, a number of customers tuned into the CBS Late Show commercial are shown during sequential time periods for FIG. 3 c 330, 332, 334, 336, 338, 340, and 342. In another particular illustrative embodiment, the most recent number of customers who are tuned to commercial 2 during the CBS Late Show is illustrated during time periods for FIG. 3 d 344, 346, 348, 350 and 352.

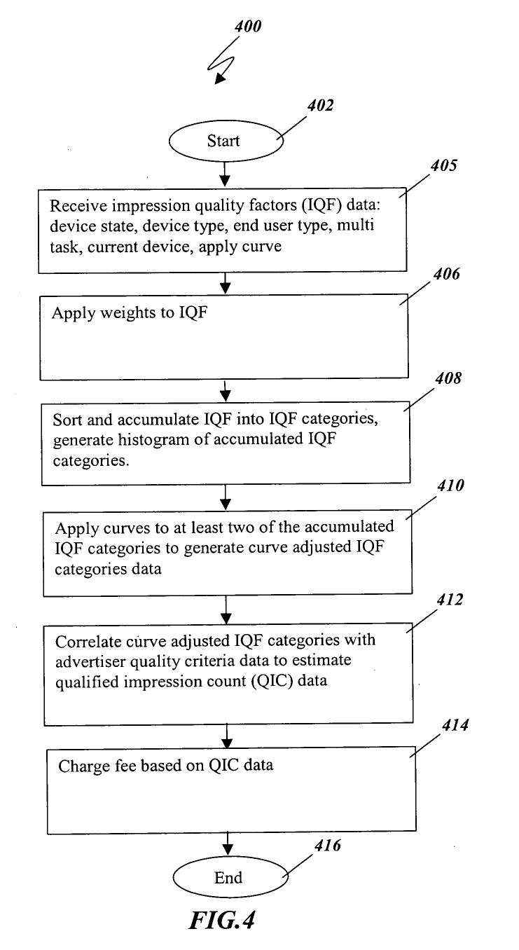

Turning now to FIG. 4 a flowchart 400 is illustrated for another particular embodiment in which functions are performed. As shown in block 402 in another particular illustrative embodiment a function starts and proceeds to block 405, where a server receives impression quality factors data comprising subscriber device state, device type, subscriber type, multitask, current state, and application curve. In another particular illustrative embodiment at block 406, the impression quality factors data are sorted into categories and weights are applied to the impression quality factors category data. At block 408, another embodiment accumulates weighted impression quality factors, and generates a histogram of the accumulated impression quality factor categories.

In another particular illustrative embodiment, an advertiser assigns weights from 1-10 to impression quality factor data categories. The impression quality factor data categories include but are not limited to impressions for particular subscriber device types for particular subscriber types. For example, impressions for an advertisement for a particular luxury car slanted toward women are assigned weights as follows: For advertisements viewed on television, a weight of 10 is assigned for women age 35-55, a weight of 7 for women age 18-35, a weight of 8 for men 35-55, a weight of 5 for men 18-35. For advertisements viewed on mobile telephones, a weight of 8 for women age 35-55, a weight of 5 for women age 18-35, a weight of 6 for men age 35-55, a weight of 4 for men age 18-35. For online commercials, a weight of 6 for women age 35-55, a weight of 3 for women age 18-35, a weight of 4 for men age 35-55, a weight of 2 for men age 18-35. A histogram of viewers sorted by impression quality factor categories is generated showing how many viewers in each impression quality factor category viewed a particular advertisement.

An additional weight point can be assigned (i.e., given a weight of 9 instead of 8) to subscribers who receive and view an advertisement on a subscriber device that is received and viewed on their preferred subscriber device as indicated by a subscriber device preference. A subscriber device preference is indicated by a subscriber profile showing that prior reception of advertisements on a particular subscriber device type are viewed and not skipped. For example, if a subscriber receives an advertisement on a television for a particular product but only views 10 seconds of a 30 second advertisement, but views the entire advertisement of the same advertisement on a mobile phone, then the subscriber's preferred subscriber device is a mobile phone and advertisements viewed on the mobile phone are given extra weight. In this case the subscriber device preference is the mobile phone. In another particular embodiment, a subscriber device preference is indicated by a subscriber selection at registration with a communication network.

Values can also be assigned for duration or how much of an advertisement a particular view watched. If a viewer only saw the first 10 seconds of a 30 second advertisement, the advertisement viewing receives only one sixth of its assigned weight and may be deemed as inappropriate for the demographic and device type for that particular viewer type, for example, males 18-35 on a mobile phone. If the same advertisement is watched for the last 20 seconds of the advertisement, the advertisement viewing receives three fourths of its assigned weight and deemed appropriate for the demographic and device type for that particular viewer type, for example, males 18-35 on a mobile phone. The weighted impression quality factors are adjusted for duration and accumulated for additional processing.

At block 410 a particular illustrative embodiment applies curves to at least two of the accumulated compression quality factor categories data to generate curve-adjusted impression quality factors categories data. In a particular embodiment, different curves are applied to different impression quality factor categories data to generate curve-adjusted impression quality factor categories data. For example, continuing with the luxury car example from above, different curves are applied to different accumulated impression quality factors categories data. An S curve is applied to data for men ages 18-35 and 35-55, a linear curve to data for women age 18-35 and an exponential curve to data for women age 35-55. In another particular illustrative embodiment, at block 412 a particular illustrative embodiment correlates the curve-adjusted impression quality factor categories data with a set of advertising advertiser quality criteria data to estimate a qualified impression count.

The curve adjusted impression quality factors categories generated in block 410, are compared to advertiser quality criteria data as follows. An advertiser provides impression quality criteria data for rating impression by device type and subscriber type. In a particular illustrative embodiment, impression quality criteria data give a value of 10 points each to every television impression viewed by a woman age 35-55 with an income over $00,000, 9 points for man age 35-55 with an income over $100,000 and 8 points for woman age 35-55 with an income $50,000-$99,000. At block 414 a fee is charged based on the qualified impression count. In another particular illustrative embodiment, the function ends at block 416.

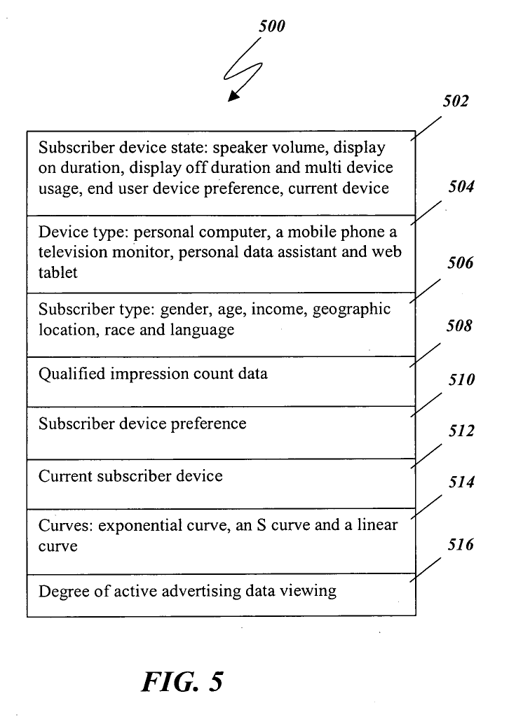

Turning now to FIG. 5 a data structure embedded in a computer readable medium is illustrated. At block 502 a first data structure field is illustrated for subscriber device state. In another particular illustrative embodiment, the advertising device state data comprise speaker volume data, display on duration data, display alteration data, and multi-device usage user device data and current end user device data. If a speaker volume is muted or low during a commercial viewing the viewing is given only one tenth credit in the accumulated qualified impression count data. If the display if turned off during a commercial is given no credit. At block 504 a second data structure field is illustrated for containing data indicative of a subscriber device type. Subscriber device type data is indicative of a device type such as a personal computer, a mobile telephone, a television monitor, personal data assistant, wire line phone and a Web tablet. Illustrated in data structure field 506 is a subscriber type field for containing data indicative of an advertising subscriber type. The subscriber type comprises gender, age, income, geographic location, interests, languages spoken, etc. which can be gleaned from network registration data, or from buying and viewing habits associated with the IPTV or triple-play communication network offering IPTV, VoIP and Internet.

A subscriber type comprises data indicative of gender, age, income, geographic location, interests, marital status, education and language. At block 508 is a qualified impression count data field is illustrated for containing data indicative of a qualified impression count. At block 510 a subscriber device preference data field is illustrated for containing data indicative of an end-user preference device. At block 512 a current end user device field is illustrated for containing data indicative of a current end user device. The current subscriber device is the subscriber device (IPTV display, mobile MP3/video player, DVR, mobile phone, personal computer, web browser lap top computer, etc.) which the subscriber is currently using. Advertising may be targeted to current subscriber devices in an attempt to register more advertising impressions or viewings of a particular commercial. At block 514 a curves data structure field is illustrated for containing data indicative of a curve for applying to the impression quality data. A curve may be an exponential curve, an S curve or a linear curve or another curve selected to represent an advertiser's desired impression quality fee. At block 516 a data structure field is illustrated for weighting data indicative of any degree of active advertising viewing. A degree of active advertising viewing may be assigned based on whether the advertisement is viewed on the current end user device. For example, an IPTV commercial may be joined in a particular multicast join associated with a particular subscriber, indicating that the commercial is being viewed by the subscriber, however, if the end user is also on a computer and/or a mobile phone, i.e. multiple device usage or using multiple devices at the same time, the degree of active advertising viewing may be adjusted down from a level of 10 to level of 5. The weight assigned to an impression quality factor category may be adjusted down or up by the degree of active advertising viewing.

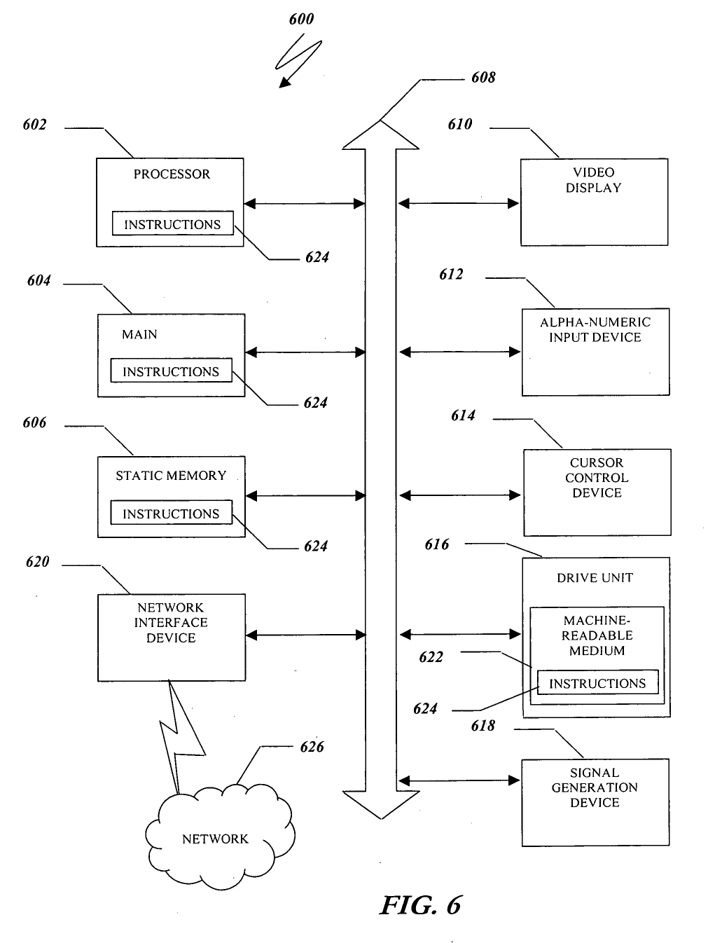

FIG. 6 is a diagrammatic representation of a machine in the form of a computer system 600 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine.

It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., liquid crystals display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface.

The disk drive unit 616 may include a machine-readable medium 622 on which is stored one or more sets of instructions (e.g., software 624) embodying any one or more of the methodologies or functions described herein, including those methods illustrated in herein above. The instructions 624 may also reside, completely or at least partially, within the main memory 604, the static memory 606, and/or within the processor 602 during execution thereof by the computer system 600. The main memory 604 and the processor 602 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620. The machine readable medium may also contain a data structure for containing data useful in providing a functional relationship between the data and a machine or computer in an illustrative embodiment of the disclosed system and method.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived there from, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer readable medium containing computer program instructions that when executed by a computer perform a method for estimating a qualified impression count in a communication network, the computer program comprising:
instructions to receive at a server, impression quality factors data comprising subscriber device state data indicative of a degree of active advertising data viewing, subscriber device type data indicative of a type of subscriber device receiving the advertising data and subscriber type data indicative of a type of subscriber viewing the advertising data;
instructions to sort the impression quality factors data into impression quality factors categories data;
instructions to apply weights to the sorted impression quality factors categories data;
instructions to accumulate the weighted impression quality factors categories data into the impression quality factors categories;
instructions to apply unique curves to at least two of the accumulated impression quality factors categories data to generate curve adjusted impression quality factors categories data;
instructions to correlate the curve adjusted impression quality factors categories data with advertising quality criteria data; and
instructions to estimate the qualified impression count from the correlation.

2. The medium of claim 1, wherein the impression quality factors data is received from at least one of the set consisting of a subscriber device and a local server, the computer program further comprising:
instructions to generate a histogram of accumulated weighted impression quality factors categories data.

3. The medium of claim 1, the computer program further comprising:
instructions to charge a fee based on the qualified impression count.

4. The medium of claim 1, wherein the plurality of curves are selected from the group consisting of an exponential curve, an S curve and a linear curve.

5. The medium of claim 1, wherein the subscriber device type is selected from the group consisting of a personal computer, a mobile phone a television monitor, personal data assistant and web tablet.

6. The medium of claim 1, wherein the subscriber type is selected from the group consisting of gender, age, income, geographic location, race and language.

7. The medium of claim 1, wherein the subscriber device state is selected from the group consisting of speaker volume, display on duration, display off duration and multiple device usage, end user device preference, and current device.

8. The medium of claim 7, wherein the device state is collected at programmable time intervals, t selected to filter out channel surfing.

9. The medium of claim 1, wherein applying weights to sorted impression quality factors categories data is based on at least one selected from the group consisting of subscriber type, level of active viewing, duration of viewing, preferred subscriber device and subscriber device type.

10. A system for estimating a qualified impression count in a communication network, the system comprising:
a processor in data communication with a computer readable medium; and
a computer program embedded in the computer readable medium, the computer program comprising instructions to receive at a server, impression quality factors data comprising subscriber device state data indicative of a degree of active advertising data viewing, subscriber device type data indicative of a type of subscriber device receiving the advertising data and subscriber type data indicative of a type of subscriber viewing the advertising data, instructions to sort the impression quality factors data into impression quality factors categories data, instructions to apply weights to the sorted impression quality factors categories data, instructions to accumulate the weighted impression quality factors categories data into the impression quality factors categories; instructions to apply unique curves to at least two of the accumulated impression quality factors categories data to generate curve adjusted impression quality factors categories data; instructions to correlate the curve adjusted impression quality factors categories data with advertising quality criteria data; and instructions to estimate the qualified impression count from the correlation.

11. The system of claim 10, wherein the impression quality factors data are received from at least one of the set consisting of a subscriber device and a local server, the computer program further comprising:
instructions to generate a histogram of accumulated weighted impression quality factors categories data.

12. The system of claim 10, the computer program further comprising:
instructions to charge a fee based on the qualified impression count.

13. The system of claim 10, wherein the plurality of curves are selected from the group consisting of an exponential curve, an S curve and a linear curve.

14. The system of claim 10, wherein the subscriber device type is selected from the group consisting of a personal computer, a mobile phone a television monitor, personal data assistant and web tablet.

15. The system of claim 10, wherein the subscriber type is selected from the group consisting of gender, age, income, geographic location, race and language.

16. The system of claim 10, wherein the subscriber device state is selected from the group consisting of speaker volume, display on duration, display off duration and multiple device usage, end user device preference, and current device.

17. The system of claim 16, wherein the device state is collected at programmable time intervals, t selected to filter out channel surfing.

18. The system of claim 10, wherein applying weights to sorted impression quality factors categories data is based on at least one selected from the group consisting of subscriber type level of active viewing duration of viewing, preferred subscriber device, and subscriber device type.

19. A data structure embedded in a computer readable medium, the data structure comprising:
a first field for storing data indicative of qualified impression count data based on curve adjusted impression quality data estimated by applying a curve to accumulated quality factors category data.

20. The data structure of claim 19, further comprising:
a second field for storing data indicative of a curve adjusted advertising impression quality for at least one of a plurality impression quality factors categories data, wherein the curve adjusted impression quality data is estimated by applying a curve to accumulated quality factors categories data.

21. The data structure of claim 19, further comprising:
a third field for storing data representing an advertising device state indicative of a degree of active advertising viewing data, wherein the degree of active advertising viewing is used to adjust the weighting of the plurality impression quality factors categories data.

22. The data structure of claim 19, further comprising:
a fourth field for storing data representing a subscriber device type indicative of a type of advertising device selected from the group consisting of a personal computer, a mobile phone, a television monitor, a personal data assistant and a web tablet.

23. A computer readable medium containing computer program instructions that when executed by a computer perform a method for sending impression quality factors data for estimating a qualified impression count in a communication network, the computer program comprising:
instructions to collect impression quality factors data at a subscriber device; and
instructions to send from the subscriber device to a server, the impression quality factors data comprising subscriber device state data indicative of a degree of active advertising data viewing, subscriber device type data indicative of a type of subscriber device receiving the advertising data and subscriber type data indicative of a type of subscriber viewing the advertising data.

24. A subscriber device for estimating a qualified impression count in a communication network, the subscriber device comprising:
a processor in data communication with a computer readable medium; and
a computer program embedded in the computer readable medium, the computer program comprising instructions to collect impression quality factors data at the subscriber device and instructions to send from the subscriber device to a server, impression quality factors data comprising subscriber device state data indicative of a degree of active advertising data viewing, subscriber device type data indicative of a type of subscriber device receiving the advertising data and subscriber type data indicative of a type of subscriber viewing the advertising data.
